(19) United States
(12) Patent Application Publication
(10) Pub. No.: US 2024/0034149 A1
(43) Pub. Date: Feb. 1, 2024

(54) VEHICLE

(71) Applicant: SUBARU CORPORATION, Tokyo (JP)

(72) Inventors: Takuya HOMMA, Tokyo (JP); Tsukasa MIKUNI, Tokyo (JP); Junichi MOTOYAMA, Tokyo (JP); Ryota NAKAMURA, Tokyo (JP); Kazuhiro HAYAKAWA, Tokyo (JP)

(21) Appl. No.: 18/347,859

(22) Filed: Jul. 6, 2023

(30) Foreign Application Priority Data
Jul. 29, 2022 (JP) 2022-121291

(51) Int. Cl. B60K 35/00

(52) U.S. Cl. CPC B60K 35/00; B60K 2370/166; B60K 2370/177; B60K 2370/563; B60K 2370/577

(57) ABSTRACT

A vehicle includes a display unit, a monitoring unit, and a display controller. The display unit is configured to display data including a shared image shared with a mobile terminal. The mobile terminal is configured to establish coupling by communication. The monitoring unit is configured to monitor a processing load state. The display controller is configured to control a display mode of the shared image in accordance with the processing load state and an amount of data regarding the shared image.

### CROSS-REFERENCE TO RELATED APPLICATIONS

The present application claims priority from Japanese Patent Application No. 2022-121291 filed on Jul. 29, 2022, the entire contents of which are hereby incorporated by reference.

### BACKGROUND

The disclosure relates to a vehicle.

Recently, development of so-called connection techniques has been made. The connection techniques include coupling a vehicle to a vehicle, or a vehicle to a portable terminal, etc. by communication.

As an application example of such techniques, a technique is also known that includes coupling a vehicle to a portable terminal, etc. by communication, and displaying image data supplied from the portable terminal on an image display device of the vehicle.

As a technique of this kind, for example, a technique of an in-vehicle device mounted on an automobile has been disclosed. This technique includes displaying a moving image transferred from a mobile device coupled to the in-vehicle device, on a display device of the in-vehicle device. For example, reference is made to, for example, Japanese Unexamined Patent Application Publication (JP-A) No. 2013-119263.

### SUMMARY

An aspect of the disclosure provides a vehicle including a display unit, a monitoring unit, and a display controller. The display unit is configured to display data including a shared image shared with a mobile terminal. The mobile terminal is configured to establish coupling by communication. The monitoring unit is configured to monitor a processing load state. The display controller is configured to control a display mode of the shared image in accordance with the processing load state and an amount of data regarding the shared image.
An aspect of the disclosure provides a vehicle including a display unit and circuitry. The display unit is configured to display data including a shared image shared with a mobile terminal. The mobile terminal is configured to establish coupling by communication. The circuitry is configured to monitor a processing load state. The circuitry is configured to control a display mode of the shared image in accordance with the processing load state and an amount of data regarding the shared image.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a configuration of a vehicle according to a first embodiment of the disclosure.

FIG. 2 is a block diagram illustrating a configuration of a display controller according to the first embodiment of the disclosure.

FIG. 3 is a flowchart of processing in the vehicle according to the first embodiment of the disclosure.

FIG. 4 is a flowchart of processing in the vehicle according to the first embodiment of the disclosure.

FIG. 5 is a flowchart of processing in the vehicle according to the first embodiment of the disclosure.

FIG. 6 is a block diagram illustrating a configuration of a vehicle according to a second embodiment of the disclosure.

FIG. 7 is a block diagram illustrating a configuration of a display controller according to the second embodiment of the disclosure.

FIG. 8 is a flowchart of processing in the vehicle according to the second embodiment of the disclosure.

FIG. 9 is a flowchart of processing in the vehicle according to the second embodiment of the disclosure.

### DETAILED DESCRIPTION

When a device in a vehicle and a portable terminal share and display a common image, the device in the vehicle may sometimes fail in displaying the image while carrying out high-load processing even if the device in the vehicle has high processing capability.

It is desirable to provide a vehicle that makes it possible to control a display mode of an image shared with a device in the vehicle and a portable terminal, without any inconvenience, depending on a current processing state of the device in the vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### First Embodiment

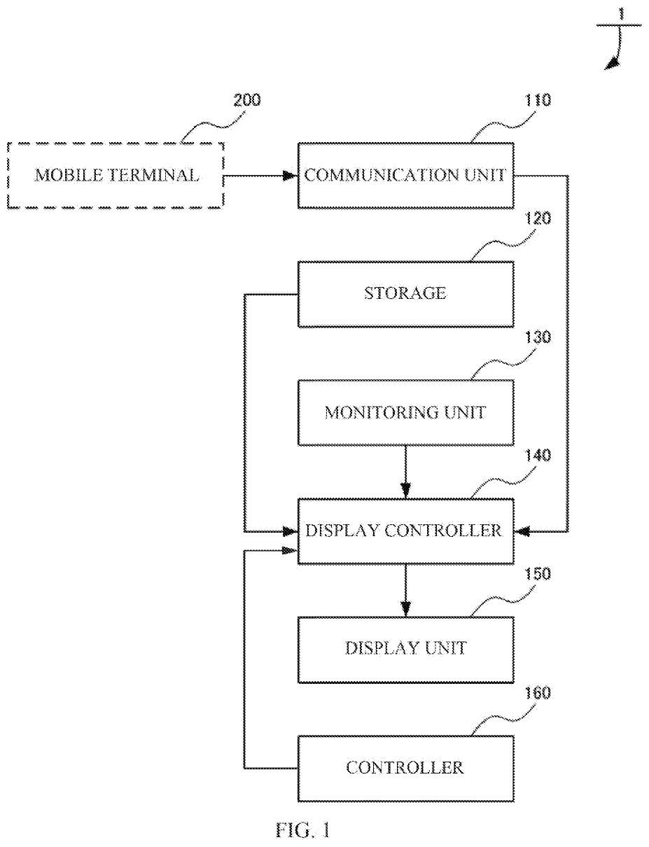

A vehicle 1 according to a first embodiment of the disclosure is described with reference to FIGS. 1 to 5.

### <Configuration of Vehicle 1>

Referring to FIG. 1, the vehicle 1 according to the first embodiment may include, for example, a communication unit 110, a storage 120, a monitoring unit 130, a display controller 140, a display unit 150, and a controller 160.

The communication unit 110 may include, for example, a communication module configured to communicate with a mobile terminal 200. As a communication mode, for example, the communication unit 110 is configured to establish communication in a limited area such as Wi-Fi (registered trademark) or Bluetooth (registered trademark).

The communication unit 110 may transmit and receive a shared image shared with the mobile terminal 200. The communication unit 110 may also transmit and receive, for example, a signal that synchronizes applications such as a Web conference and an artificial intelligence (AI) concierge.

The storage 120 may include, for example, a random access memory (RAM). The storage 120 may hold, for example, the shared image.

The storage 120 may further hold specifications such as data processing capability of a controller including a display controller described later.

The monitoring unit 130 may monitor a processing load state in real time.

Data regarding the processing load state as a monitoring result of the monitoring unit 130 may be outputted to the display controller described below.

The display controller 140 controls a display mode of the shared image in accordance with the processing load state as the monitoring result of the monitoring unit 130 and an amount of data regarding the shared image.

In one example, the shared image may be an avatar that represents an object in shared virtual reality. The avatar may be used in a Web conference, as an AI concierge, or both. The avatar may be, for example, a three-dimensional image. When the processing load state as the monitoring result of the monitoring unit 130 is a high load state, the display controller 140 may allow the avatar to be displayed, while changing the three-dimensional image of the avatar to a two-dimensional image as the display mode.

In another example, the shared image may be the avatar. The avatar may be used in a Web conference, as an AI concierge, or both. The avatar may be, for example, a moving image. When the processing load state as the monitoring result of the monitoring unit 130 is the high load state, the display controller 140 may allow the avatar to be displayed, while suppressing the number of transitions of the moving image of the avatar. For example, the display controller 140 may perform a process of thinning out frame images at regular intervals.

The display controller 140 may perform both the control of changing the three-dimensional image of the avatar to the two-dimensional image as the display mode, and the control of suppressing the number of transitions of the moving image of the avatar, in accordance with the processing load state as the monitoring result of the monitoring unit 130.

The display unit 150 may include, for example, a display including, for example, a liquid crystal display panel. The display unit 150 may display, on the display, display data inputted from the display controller 140. The display data may include, for example, characters, figures, illustrations, and moving images.

The controller 160 may control operation of the entire vehicle 1 in accordance with a control program held in, for example, an unillustrated read only memory (ROM).

In this embodiment, the controller 160 may allow the display controller 140 to carry out a desired control.

### <Configuration of Display Controller 140>

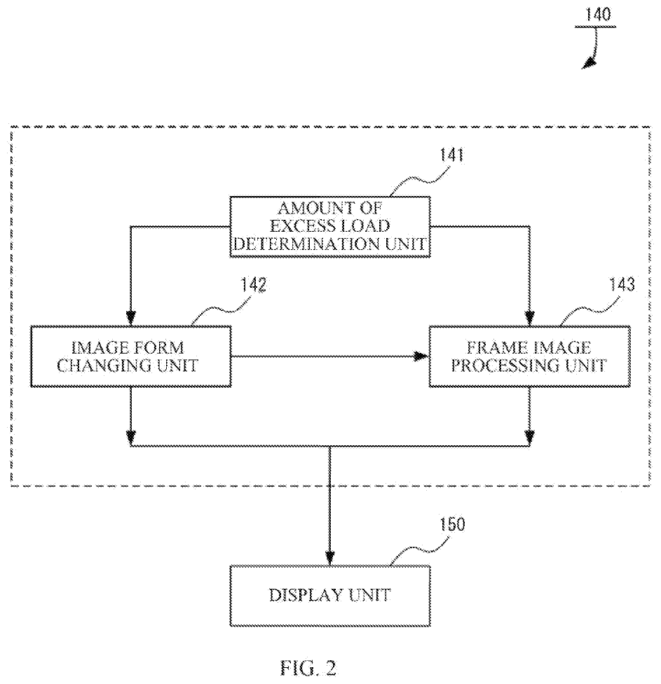

As illustrated in FIG. 2, the display controller 140 according to this embodiment may include, for example, an amount of excess load determination unit 141, an image form changing unit 142, and a frame image processing unit 143.

The amount of excess load determination unit 141 may determine, in real time, an amount of excess load to be allocated to a display control, based on data regarding the processing load state as the monitoring result of the monitoring unit 130 and specifications such as the data processing capability of the controller 160 including the display controller 140. The specifications may be held in the storage 120.

The controller 160 may determine whether to change an image form, whether to perform a frame image process, or both, based on the amount of excess load determined by the amount of excess load determination unit 141 and the amount of data regarding the shared image.

The image form changing unit 142 may carry out, for example, a process of changing a three-dimensional image to a two-dimensional image.

In one example, when the controller 160 determines that it is appropriate to change the image form based on the amount of excess load determined by the amount of excess load determination unit 141 and the amount of data regarding the shared image, the image form changing unit 142 may carry out, for example, the process of changing the three-dimensional image to the two-dimensional image.

The image form changing unit 142 may output the display data in which the image form has been changed, to the display unit 150.

Moreover, when the controller 160 determines that it is appropriate to change the image form and perform the frame image process based on the amount of excess load determined by the amount of excess load determination unit 141 and the amount of data regarding the shared image, the image form changing unit 142 may output the display data in which the image form has been changed, to the frame image processing unit 143 in accordance with a control signal of the controller 160.

For example, when the display data is moving image data, the frame image processing unit 143 may perform the process of thinning out the frame images at the regular intervals.

The controller 160 may determine the regular intervals based on the amount of excess load determined by the amount of excess load determination unit 141 and the amount of data regarding the shared image. The frame image processing unit 143 may be supplied with a control signal regarding the regular intervals thus determined, and carry out the processing.

The frame image processing unit 143 may output the processed display data to the display unit 150.

### <Processing in Vehicle 1, Part 1>

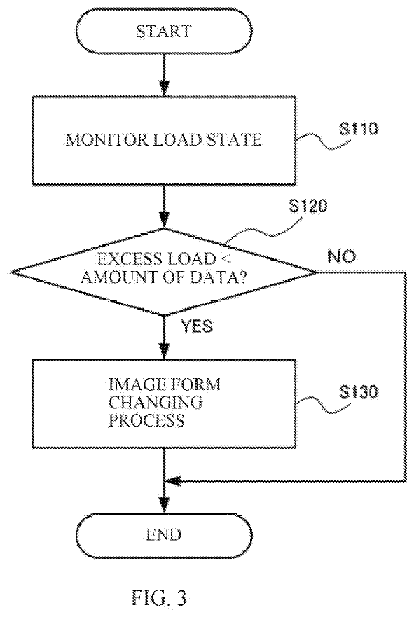

Processing in the vehicle 1, part 1 according to this embodiment is described with reference to FIG. 3.

The monitoring unit 130 may monitor the processing load state in real time (step S110).

The amount of excess load determination unit 141 in the display controller 140 may determine, in real time, the amount of excess load to be allocated to the display control, based on the data regarding the processing load state as the monitoring result of the monitoring unit 130 and the specifications such as the data processing capability of the controller 160 including the display controller 140. The specifications may be held in the storage 120. The amount of excess load determination unit 141 may determine whether or not the amount of data is larger than the amount of excess load (step S120). When the amount of excess load determination unit 141 determines that the amount of data is smaller than the amount of excess load (“NO” in step S120), the amount of excess load determination unit 141 may end the processing.

When the amount of excess load determination unit 141 determines that the amount of data is larger than the amount of excess load (“YES” in step S120), and the controller 160 determines that it is appropriate to perform an image form changing process, based on the amount of excess load determined by the amount of excess load determination unit 141 and the amount of data regarding the shared image, the controller 160 may instruct the image form changing unit 142 to perform the image form changing process. The image form changing unit 142 may carry out, for example, the process of changing the three-dimensional image to the two-dimensional image (step S130). The image form changing unit 142 may output the processed display data to the display unit 150, and end the processing.

### <Processing in Vehicle 1, Part 2>

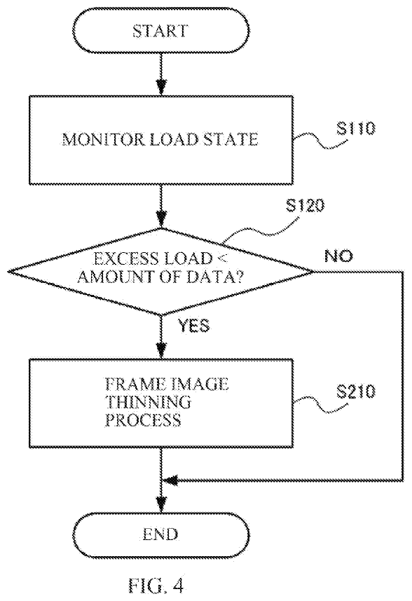

The processing in the vehicle 1, part 2 according to this embodiment is described with reference to FIG. 4.

The monitoring unit 130 may monitor the processing load state in real time (step S110).

The amount of excess load determination unit 141 in the display controller 140 may determine, in real time, the amount of excess load to be allocated to the display control, based on the data regarding the processing load state as the monitoring result of the monitoring unit 130 and the specifications such as the data processing capability of the controller 160 including the display controller 140. The specifications may be held in the storage 120. The amount of excess load determination unit 141 may determine whether or not the amount of data is larger than the amount of excess load (step S120). When the amount of excess load determination unit 141 determines that the amount of data is smaller than the amount of excess load (“NO” in step S120), the amount of excess load determination unit 141 may end the processing.

When the amount of excess load determination unit 141 determines that the amount of data is larger than the amount of excess load (“YES” in step S120), and the controller 160 determines that it is appropriate to perform the frame image process, based on the amount of excess load determined by the amount of excess load determination unit 141 and the amount of data regarding the shared image, the controller 160 may instruct the frame image processing unit 143 to perform a frame image thinning process. For example, when the display data is the moving image data, the frame image processing unit 143 may carry out the process of thinning out the frame images at the regular intervals (step S210). The frame image processing unit 143 may output the processed display data to the display unit 150, and end the processing.

### <Processing in Vehicle 1, Part 3>

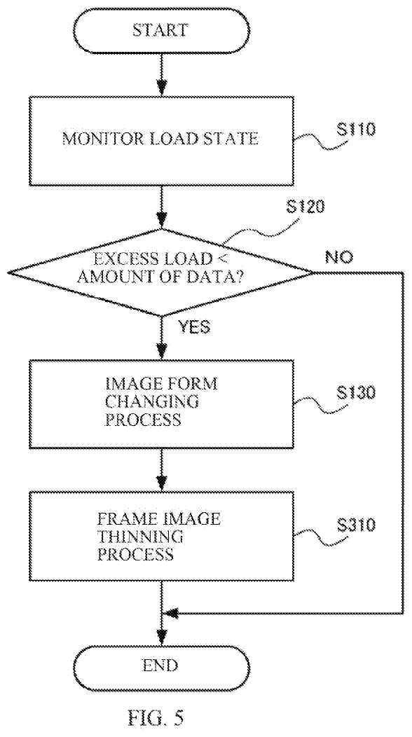

The processing in the vehicle 1, part 3 according to this embodiment is described with reference to FIG. 5.

The monitoring unit 130 may monitor the processing load state in real time (step S110).

The amount of excess load determination unit 141 in the display controller 140 may determine, in real time, the amount of excess load to be allocated to the display control, based on the data regarding the processing load state as the monitoring result of the monitoring unit 130 and the specifications such as the data processing capability of the controller 160 including the display controller 140. The specifications may be held in the storage 120. The amount of excess load determination unit 141 may determine whether or not the amount of data is larger than the amount of excess load (step S120). When the amount of excess load determination unit 141 determines that the amount of data is smaller than the amount of excess load (“NO” in step S120), the amount of excess load determination unit 141 may end the processing.

When the amount of excess load determination unit 141 determines that the amount of data is larger than the amount of excess load (“YES” in step S120), and the controller 160 determines that it is appropriate to perform both the image form changing process and the frame image process, based on the amount of excess load determined by the amount of excess load determination unit 141 and the amount of data regarding the shared image, the controller 160 may, first, instruct the image form changing unit 142 to perform the image form changing process. The image form changing unit 142 may carry out, for example, the process of changing the three-dimensional image to the two-dimensional image (step S130). The image form changing unit 142 may output the processed display data to the frame image processing unit 143.

Thereafter, the controller 160 may instruct the frame image processing unit 143 to perform the frame image process. For example, when the display data is the moving image data, the frame image processing unit 143 may carry out the process of thinning out the frame images at the regular intervals (step S310) on the display data inputted from the image form changing unit 142. The frame image processing unit 143 may output the processed display data to the display unit 150, and end the processing.

### <Workings and Effects>

As described, the display controller 140 of the vehicle 1 according to this embodiment controls the display mode of the shared image in accordance with the processing load state obtained from the monitoring unit 130 and the amount of data regarding the shared image held in the storage 120.

That is, when the amount of excess load is smaller than the amount of data regarding the shared image, the display controller 140 may reduce the amount of data regarding the shared image to an amount corresponding to the amount of excess load.

Hence, it is possible to control the display mode of the image shared with the device in the vehicle and the portable terminal, without any inconvenience, depending on the current processing state of the device in the vehicle. This leads to prevention of temporary interruption of image display.

In the vehicle 1 according to this embodiment, the shared image may be the avatar. The avatar may be used in the Web conference, as the AI concierge, or both. The avatar may be the three-dimensional image. When the processing load state obtained from the monitoring unit 130 is the high load state, the display controller 140 may allow the display unit 150 to display the avatar, while changing the three-dimensional image of the avatar to the two-dimensional image.

That is, when the processing load state is the high load state and the amount of excess load is smaller than the amount of data regarding the avatar as the shared image, the display controller 140 may reduce the amount of data regarding the shared image to the amount corresponding to the amount of excess load by changing the three-dimensional image of the avatar to the two-dimensional image.

Hence, it is possible to control the display mode of the image shared with the device in the vehicle and the portable terminal, without any inconvenience, depending on the current processing state of the device in the vehicle. This leads to the prevention of the temporary interruption of the image display.

In the vehicle 1 according to this embodiment, when the processing load state obtained from the monitoring unit 130 is the high load state, the display controller 140 may allow the display unit 150 to display the avatar, while suppressing the number of transitions of the moving image of the avatar.
That is, when the processing load state is the high load state and the amount of excess load is smaller than the amount of data regarding the avatar as the shared image, the display controller 140 may thin out the frame images constituting the avatar, to reduce the amount of data regarding the shared image to the amount corresponding to the amount of excess load.
Hence, it is possible to control the display mode of the image shared with the device in the vehicle and the portable terminal, without any inconvenience, depending on the current processing state of the device in the vehicle. This leads to the prevention of the temporary interruption of the image display.

### Second Embodiment

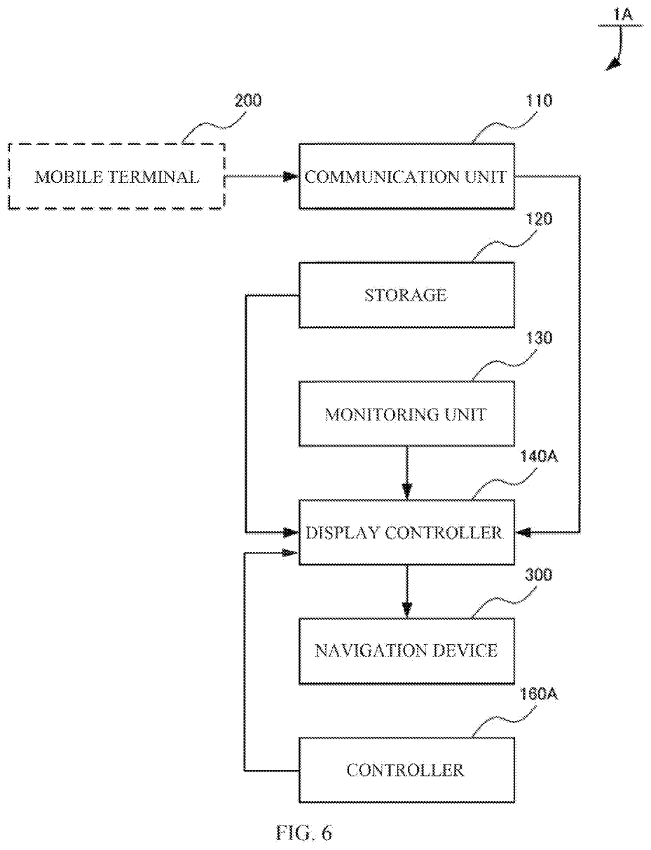

A vehicle 1A according to a second embodiment of the disclosure is described with reference to FIGS. 6 to 9.

### <Configuration of Vehicle 1A>

As illustrated in FIG. 6, the vehicle 1A according to this embodiment may include, for example, the communication unit 110, the storage 120, the monitoring unit 130, a display controller 140A, a controller 160A, and a navigation device 300.

The constituent elements having the same reference numerals as in the first embodiment have similar configurations and workings, and detailed description thereof is omitted.

The shared image may be, for example, a map image. When the processing load state as the monitoring result of the monitoring unit 130 is the high load state, the display controller 140A may control the display mode within a range devoid of impairment of travel safety.

In one example, when the processing load state as the monitoring result of the monitoring unit 130 is the high load state, and the map image as the shared image is a three-dimensional image, the display controller 140A may change the three-dimensional image of the map image to a two-dimensional image as the display mode.

Moreover, when the processing load state as the monitoring result of the monitoring unit 130 is the high load state, the display controller 140A may delete, from the display data, an image of an object such as a building, etc. located depthwise far away from a travel path, within the range devoid of the impairment of the travel safety.

The display controller 140 may perform both the control of changing the three-dimensional image of the map image to the two-dimensional image as the display mode, and a control of deleting the image of the object such as the building, etc. located depthwise far away from the travel path, based on the processing load state as the monitoring result of the monitoring unit 130.

The controller 160A may control operation of the entire vehicle 1A in accordance with a control program held in, for example, an unillustrated ROM.

In this embodiment, the controller 160A may allow the display controller 140A to carry out a desired control.

The navigation device 300 may search for route data, display the route data, and provide route guidance. The navigation device 300 may include a display such as a liquid crystal display panel. The navigation device 300 may be allowed, by the display controller 140A, to display, on the display, the map image as the shared image of which the display mode is controlled.

### <Configuration of Display Controller 140A>

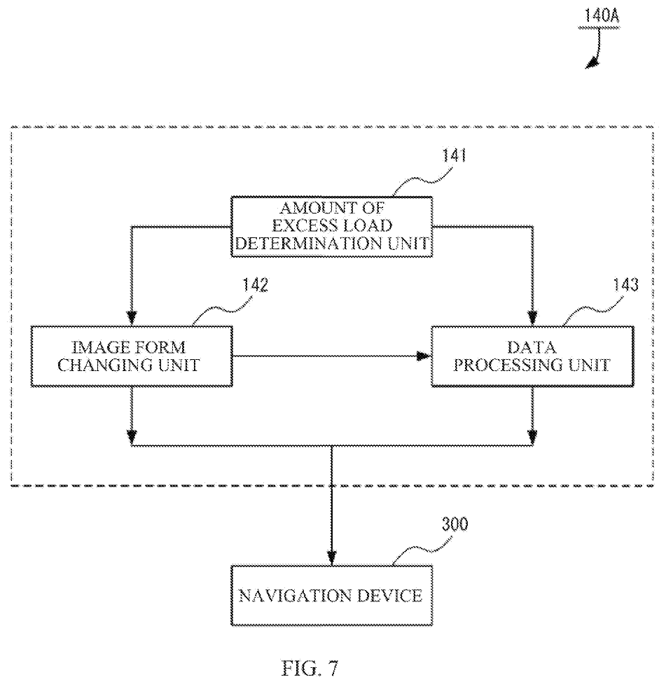

As illustrated in FIG. 7, the display controller 140A according to this embodiment may include, for example, the amount of excess load determination unit 141, the image form changing unit 142, and a data processing unit 144.

The constituent elements having the same reference numerals as in the first embodiment have similar configurations and workings, and detailed description thereof is omitted.

For example, when the processing load state as the monitoring result of the monitoring unit 130 is the high load state, the data processing unit 144 may carry out a data thinning process. The data thinning process may include, for example, a process of deleting, from the display data, the image of the object such as the building, etc. located depthwise far away from the travel path, within the range devoid of the impairment of the travel safety.

The data processing unit 144 may output the display data subjected to the data thinning process, to the navigation device 300.

Moreover, when the controller 160 determines that it is appropriate to change the image form and perform the data thinning process including deletion as described above, based on the amount of excess load determined by the amount of excess load determination unit 141 and the amount of data regarding the shared image, the data processing unit 144 may carry out the data thinning process on the display data in which the image form has been changed in the image form changing unit 142, in accordance with a control signal of the controller 160.

### <Processing in Vehicle 1A, Part 4>

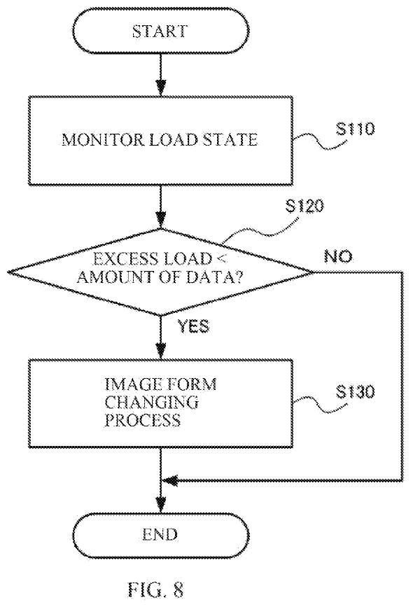

Processing in the vehicle 1A, part 4 according to this embodiment is described with reference to FIG. 8.

The monitoring unit 130 may monitor the processing load state in real time (step S110).

The amount of excess load determination unit 141 in the display controller 140A may determine, in real time, the amount of excess load to be allocated to the display control, based on the data regarding the processing load state as the monitoring result of the monitoring unit 130 and the specifications such as the data processing capability of the controller 160A including the display controller 140A. The specifications may be held in the storage 120. The amount of excess load determination unit 141 may determine whether or not the amount of data is larger than the amount of excess load (step S120). When the amount of excess load determination unit 141 determines that the amount of data is smaller than the amount of excess load (“NO” in step S120), the amount of excess load determination unit 141 may end the processing.

When the amount of excess load determination unit 141 determines that the amount of data is larger than the amount of excess load (“YES” in step S120), and the controller 160A determines that it is appropriate to perform the image form changing process, based on the amount of excess load determined by the amount of excess load determination unit 141 and the amount of data regarding the shared image, the controller 160A may instruct the image form changing unit 142 to perform the image form changing process. The image form changing unit 142 may carry out, for example, the process of changing the three-dimensional image to the two-dimensional image (step S130). The image form changing unit 142 may output the processed display data to the navigation device 300, and end the processing.

### <Processing in Vehicle 1A, Part 5>

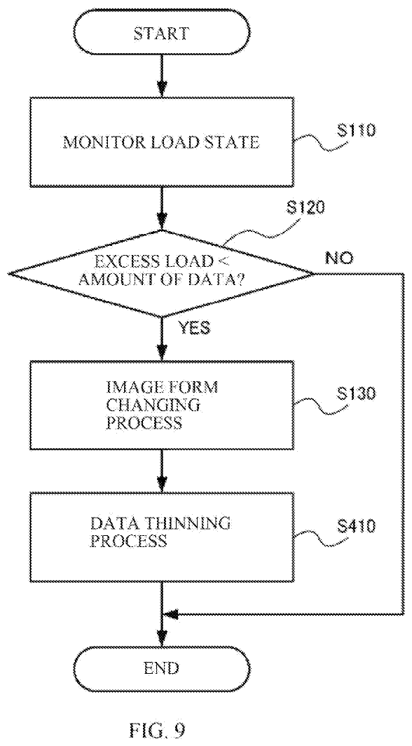

The processing in the vehicle 1A, part 5 according to this embodiment is described with reference to FIG. 9.

The monitoring unit 130 may monitor the processing load state in real time (step S110).

The amount of excess load determination unit 141 in the display controller 140A may determine, in real time, the amount of excess load to be allocated to the display control, based on the data regarding the processing load state as the monitoring result of the monitoring unit 130 and the specifications such as the data processing capability of the controller 160A including the display controller 140A. The specifications may be held in the storage 120. The amount of excess load determination unit 141 may determine whether or not the amount of data is larger than the amount of excess load (step S120). When the amount of excess load determination unit 141 determines that the amount of data is smaller than the amount of excess load (“NO” in step S120), the amount of excess load determination unit 141 may end the processing.

When the amount of excess load determination unit 141 determines that the amount of data is larger than the amount of excess load (“YES” in step S120), and the controller 160A determines that it is appropriate to perform both the image form changing process and the data thinning process based on the amount of excess load determined by the amount of excess load determination unit 141 and the amount of data regarding the shared image, the controller 160A may, first, instruct the image form changing unit 142 to perform the image form changing process. The image form changing unit 142 may carry out, for example, the process of changing the three-dimensional image to the two-dimensional image (step S130), and output the processed display data to the data processing unit 144.

Thereafter, the controller 160A may instruct the data processing unit 144 to perform the data thinning process. The data processing unit 144 may perform, on the display data inputted from the image form changing unit 142, the process of deleting, from the display data, the image of the object such as the building, etc. located depthwise far away from the travel path, within the range devoid of the impairment of the travel safety (step S410). The data processing unit 144 may output the processed display data to the navigation device 300, and end the processing.

### <Workings and Effects>

As described, when the shared image is the map image, and the processing load state is the high load state, the display controller 140A of the vehicle 1A according to this embodiment may control the display mode within the range devoid of the impairment of the travel safety.

That is, when the shared image is the map image and the processing load state is the high load state, the display controller 140A may performs the display control including changing the three-dimensional image of the map image to the two-dimensional image, within the range devoid of the impairment of the travel safety. Furthermore, if necessary, the display controller 140A may carry out, for example, the process of deleting the image of the object such as the building, etc. located depthwise far away from the travel path, from the map image as the two-dimensional image.

Hence, it is possible to control the display mode of the shared image shared with the device in the vehicle and the portable terminal, without any inconvenience, depending on the current processing state of the device in the vehicle. This leads to the prevention of the temporary interruption of the image display.

### Modification Example 1

In the forgoing description of this embodiment, for example, when the processing load state as the monitoring result of the monitoring unit 130 is the high load state and the map image as the shared image is the three-dimensional image, the display controller 140A may change the three-dimensional image of the map image to the two-dimensional image as the display mode. Alternatively, when the processing load state as the monitoring result of the monitoring unit 130 is the high load state, the display controller 140A may delete, from the display6 data, the image of the object such as the building, etc. located depthwise far away from the travel path, within the range devoid of the impairment of the travel safety. However, the display controller 140A may allow the image to be displayed, while enlarging the image as the display mode, within the range devoid of the impairment of the travel safety.

In this case, although it depends on how high the processing load state is, when the processing load state is a slightly high load state, it is possible to prevent the temporary interruption of the image display by changing the display mode to allow the image to be displayed, while enlarging the image.

In some embodiments, it is possible to implement the vehicles 1 and 1A of the example embodiments of the disclosure by recording the process to be executed by, for example, the display controllers 140 and 140A, and the controllers 160 and 160A on a non-transitory recording medium readable by a computer system, and causing the computer system to load the program recorded on the non-transitory recording medium onto, for example, the display controllers 140 and 140A, and the controllers 160 and 160A to execute the program. The computer system as used herein may encompass an operating system (OS) and hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The display controllers 140 and 140A, and the controllers 160 and 160A illustrated in FIGS. 1 and 6 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the display controllers 140 and 140A, and the controllers 160 and 160A. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the display controllers 140 and 140A, and the controllers 160 and 160A illustrated in FIGS. 1 and 6.

1. A vehicle comprising:
a display unit configured to display data including a shared image shared with a mobile terminal, the mobile terminal being configured to establish coupling by communication;
a monitoring unit configured to monitor a processing load state; and
a display controller configured to control a display mode of the shared image in accordance with the processing load state and an amount of data regarding the shared image.

2. The vehicle according to claim 1, wherein
the shared image is an avatar that represents an object in shared virtual reality,
the avatar is a three-dimensional image, and
the display controller is configured to, when the processing load state is a high load state, allow the display unit to display the avatar, while changing the three-dimensional image of the avatar to a two-dimensional image.

3. The vehicle according to claim 1, wherein
the shared image is an avatar that represents an object in shared virtual reality,
the avatar is a moving image, and
the display controller is configured to, when the processing load state is a high load state, allow the display unit to display the avatar, while suppressing a number of transitions of the moving image of the avatar.

4. The vehicle according to claim 1, wherein
the shared image is a map image,
the map image is a three-dimensional image, and
the display controller is configured to, when the processing load state is a high load state, allow the display unit to display the map image, while changing the three-dimensional image of the map image to a two-dimensional image.

5. The vehicle according to claim 1, wherein
the shared image is a map image, and
the display controller is configured to, when the processing load state is a high load state, allow
the display unit to display the map image, while deleting, from the map image, an image of an object located depthwise far away from a travel path.

6. The vehicle according to claim 1, wherein
the shared image is a map image, and
the display controller is configured to, when the processing load state is a high load state, allow the display unit to display the map image, while enlarging the map image.

7. The vehicle according to claim 2, wherein
the avatar is used in a Web conference, as an artificial intelligence concierge, or both.

8. A vehicle comprising:
a display unit configured to display data including a shared image shared with a mobile terminal, the mobile terminal being configured to establish coupling by communication; and
circuitry configured to
monitor a processing load state, and
control a display mode of the shared image in accordance with the processing load state and an amount of data regarding the shared image.
